(19) United States
(12) Patent Application Publication
(10) Pub. No.: US 2026/0217867 A1
(43) Pub. Date: Jul. 30, 2026

(54) PROCESS FOR PRODUCING RIGID CELLULOSIC PRODUCT

(71) Applicant: HONEXT MATERIAL, SL, Argentona (ES)

(72) Inventors: Sebel LEE YUN, Igualada (ES); Adrián ROMANÍ VÁZQUEZ, Terrassa (ES); Sara ALONSO JIMÉNEZ, Sant Quirze del Vallès (ES)

(73) Assignee: HONEXT MATERIAL, SL, Argentona (ES)

(21) Appl. No.: 19/139,732

(22) PCT Filed: Dec. 18, 2023
(86) PCT No.: PCT/EP2023/086449

§ 371 Date: Jun. 16, 2025

(30) Foreign Application Priority Data
Dec. 16, 2022 (EP) 22383233.8
Mar. 3, 2023 (EP) 23382203.0

(51) Int. Cl. C08B 1/00

(52) U.S. Cl. CPC C08B 1/00

(57) ABSTRACT

A process for producing rigid cellulosic product from raw fibrous industrial waste comprising the steps of (a) providing or producing pulped industrial waste cellulosic fibres derived from raw fibrous industrial waste, (b) enzymatically treating the pulped industrial waste cellulosic fibres to produce enzymatically treated industrial waste cellulosic fibres, maintaining the water content during enzyme treatment above 80%, (c) compressing the enzymatically treated industrial waste cellulosic fibres to produce compressed fibres, and (d) drying the compressed fibres to form a rigid cellulosic product.

The present invention is directed to a process for producing rigid cellulosic product from raw fibrous industrial waste. Specifically, the present invention relates to the enzymatic treatment of industrial waste cellulosic fibres and the subsequent processing of those enzymatically treated fibres to produce rigid cellulosic product such as board, and to the rigid cellulosic product.

Industrial waste is defined as waste that is non-reusable and cannot therefore be re-used or recycled to produce another useful product, and which otherwise, for example, would be deposited in landfill sites, or incinerated, with the associated negative environmental impact. The present invention is focused on re-using the cellulosic fibres of the aforementioned industrial waste to obtain rigid cellulosic products with mechanical properties suitable for use as, for example, construction boards.

Cellulosic fibres are considered non-reusable when at least one of the following characteristics applies:
the fibres have an average length of less than 5 mm,
the fibres have an average thickness below 0.1 mm,
the percentage of fines inside the cellulosic waste is above 10% in mass, where fines are defined as the smallest components in cellulosic fibres fraction that can pass through holes of 76 micrometres of diameter [SCAN. Mechanical and chemical pulps—Fines content. Standard CM 66:052005], or
the cellulosic fibres are mixed with other compounds provoking complexity in recycling, such other compounds include inorganic charges, synthetic compounds, and material impurities.

Waste paper and waste cardboard can be effectively recycled when it contains low levels of glues, inks, water resistant resins and other additives. Examples of these water resistant resins and additives are alkyl ketene dimers, alkenyl succinic anhydrides, epichlorohydrin, melamine, urea-formaldehyde, polymines, styrene's, dextrin or other polymers that enhance specific material properties (i.e. polyurethane, vinyl's, acrylic adhesives improve mechanical properties).

However, the recycling cost and the quality of the cellulosic products obtained can be significantly affected if the waste paper and cardboard contained large amounts of those additives, requiring additional treatment steps and/or increasing the consumption of additives or energy during the treatment of said cellulosic material.

The paper and cellulose manufacturing industry also generates significant quantities of industrial waste, including what is referred to as a liquid or primary sludge which contains cellulosic material considered non-reusable as defined by the above mentioned characteristics. This is considered to be an effluent with serious environmental liability for the manufacturer, but which the Applicant has discovered can be mitigated by suitable processing, including a proper enzymatic treatment to produce a cellulosic product, such as a construction board. It will be understood that the starting cellulose fibre for paper manufacturing can be any fibre, wood, or other plant based fibres for example, including fast-growing species such as Miscanthus.

Primary sludge is composed of around 40 to 90% by weight of cellulose fibres and around 10 to 60% by weight of inorganic fillers. These inorganic fillers are added during the paper manufacturing process to improve the properties of the paper. The raw cellulosic material derived from primary sludge described in this invention stands out for comprising a large amount of fines, more than 15% of cellulose fibres. Fines are small particles composed of cellulose, but which do not have the shape of a fibre due to their size. This particularity means that the raw cellulosic material used in the method of the present invention cannot be used for the manufacture of paper or other products that require good mechanical properties, as the ends do not confer mechanical bonds. The above-mentioned particularities of this raw cellulosic material make it very difficult to obtain products requiring processes of low humidity, pressure and temperature.

Another source of industrial waste which meets the above characterisation of the fibres is the cellulosic fibre residue stream or sludge from the textile industry where, for example, the presence of different types of cellulose fibres and plastic mixtures provokes difficulty in re-using or recycling these residues.

A further source of industrial waste which meets the above characterisation of the fibres, but is not a residue due stream from a plant which produces paper or textile is construction waste cellulose fibre, for example, the cardboard recovered when recycling gypsum boards. The gypsum-based recovery process, through a mechanical crushing action and a subsequent dry double compression, is able to separate the gypsum from the paper, obtaining a finished product with the same characteristics as natural gypsum. The recovered gypsum powder is 97.6% pure and practically free from paper. Whilst the gypsum by-product is reusable, the cellulosic fibres are typically incinerated without being used to form a useful product.

A further source of industrial waste which meets the above characterisation of the fibres is vegetal or plant based waste, such as Miscanthus, which has been used in a consumer product, that is, it is post-consumer, and considered not suitable to form a useful product.

The Applicant has discovered that with suitable processing, including enzymatic treatment of the fibres, and processing of those treated fibres, the previously non-reusable cellulosic fibres derived from industrial waste can ultimately be used to produce useful cellulosic products such as construction boards with the environmental benefits associated with re-using material that would otherwise end up in landfill, and importantly, offering cellulosic products which can perform at least as well as products derived from other cellulosic fibres and using alternative processes, which have a greater negative environmental impact.

Thus, according to the present invention, there is provided a process for producing rigid cellulosic product from raw fibrous industrial waste comprising the steps of:
(a) providing or producing pulped industrial waste cellulosic fibres derived from raw fibrous industrial waste,
(b) enzymatically treating the pulped industrial waste cellulosic fibres to produce enzymatically treated industrial waste cellulosic fibres, maintaining the water content during enzyme treatment above 80%,
(c) compressing the enzymatically treated industrial waste cellulosic fibres to produce compressed fibres, and
(d) drying the compressed fibres to form a rigid cellulosic product.

Advantageously, the process of the present invention allows the use of a proportion of raw fibrous cellulosic material derived from industrial processes, such as industrial process for the production of paper, cardboard, textile, or construction materials, or some other waste source where the residue cellulosic material would otherwise not be reusable for the reasons defined in the fibre characterisation above, typically low quality fibrous cellulosic material mainly comprising fibres shorter than 5 mm, and/or fragile fibres, and/or recycled fibres which are typically partially bonded with impurities and therefore have a reduced bonding capacity with other cellulosic fibres.

Without the enzymatic treatment, the industrial waste cellulosic fibres, such as primary sludge from the paper industry, cannot be reused to produce useful cellulosic products without using resins or glues, as the fibres are too short to provide sufficient mechanical properties to the board.

Preferably, the step of producing pulped industrial waste cellulosic fibres comprises pulping the raw fibrous industrial waste.

Preferably, the process further comprises the step of diluting the raw fibrous industrial waste in water prior to or during pulping.

Alternatively however, the raw fibrous industrial waste may not require a separate pulping step prior to enzymatic treatment, and can be supplied as already pulped fibres, that is fibres that are sufficiently individualised to be substantially free of agglomerations, which if left, leads to ineffective enzyme treatment, and reduced distribution of the fibres during forming, resulting in a non-homogeneous final product. Such a supply as already pulped fibres can be the direct output from an industrial plant, preferably a sludge output feed from a plant to produce paper or textiles. The supplied pulped fibres can be directly fed from the sludge output to the process for producing rigid cellulosic product via a conduit to the sludge output, or can be indirectly fed to the process for producing rigid cellulosic product via an intermediate storage tank.

By raw fibrous cellulosic material, it is meant material mainly composed from fibres made of cellulose and other vegetal compounds able to generate bonds with other cellulose fibres.

The enzymatic process increases the number of free hydroxyls of the fibres and enables the industrial waste fibres to crosslink and bond with other non-industrial fibres and/or each other to produce cellulosic products such as construction boards or panels with sufficient mechanical properties.

Preferably, the raw fibrous industrial waste comprises fibres having one or more of an average length of less than 5 mm, preferably less than 2 mm, and/or an average width of less than 0.1 mm, and/or a mass percentage of fines greater than 10%.

Preferably, the industrial waste fibres are derived from one or more of primary sludge obtained from the paper production industry or sludge residues from the textile production industry.

By industrial waste fibres, it is meant fibres that have been derived from an industrial process such as paper, cardboard or textile production to produce paper, cardboard or textile products, or some industrial process where the cellulosic fibres are not considered to be re-usable to form a useful cellulosic product. Waste or recycled cardboard is not considered to be industrial waste.

In the present invention, the terms primary sludge and sewage sludge may be used indistinctly.

Preferably, the process further comprises the step of diluting the raw fibrous industrial waste in water prior to or during pulping.

Preferably, the process further comprises the step of diluting the enzymatically treated industrial waste cellulosic fibres to obtain diluted enzymatically treated industrial waste cellulosic fibres with a water content of greater than 90%.

Preferably, the step of maintaining the water content during enzymatic treatment above 80% comprises maintaining the water content during enzymatic treatment greater than 80% and up to 99%, more preferably greater than 80% and up to 95%.

Preferably, the raw fibrous cellulosic material from the industrial waste will be free of large particles or clusters, bigger than 5 mm, because such particles or clusters will have a reduced or no capacity to generate bonds with other cellulose fibres. A particle size reducer, such as a crusher, a shredder, can be used prior to pulping to reduce the size or eliminate particles or clusters depending on the type of raw fibrous cellulosic material. For example, materials difficult to pulp when not reduced in size, such as miscanthus or textile waste, may require this additional particle size reduction step.

Alternatively, the raw fibrous cellulosic material can include large particles or clusters bigger than 5 mm if such particles or clusters are soluble or breakable in small particles or clusters smaller than 5 mm or fibres of any length during pulping. An example of large soluble or breakable particles or clusters can be for example cardboard or sludge lumps.

Preferably, the step of enzymatically treating the industrial waste cellulosic fibres comprises adding one or more enzymes to the industrial waste cellulosic fibres to one or more of, smooth the fibres, remove radicals from the outside of the fibres and increase the specific surface area of the fibres.

Preferably, the step of enzymatically treating the industrial waste cellulosic fibres comprises one or more of the following:
keeping the pH of the pulped fibres between 5 and 9,
maintaining the temperature above 40° C., preferably greater than 40° C. and less than 70° C. during the enzymatic treatment of step (b),
adding one or more enzymes selected from the group of xylanase, laccase, and cellulase,
adding between 0.05% to 0.5% of enzymes with respect to the dry weight of the industrial waste cellulosic fibres,
enzymatically treating the industrial waste cellulosic fibres for a period of greater than 5 minutes, preferably greater than 5 minutes and less than 60 minutes.

The Applicant has realised that for industrial cellulosic waste, the enzymatic treatment process is key, not only for the fibrillation of the fibres, but also cleaning the fibre surface using xylanase and laccase enzymes. Xylanase enzymes attack hemicellulose, which facilitates the extraction of surface layers of the cellulose fibre, thus eliminating impurities that may be carried by the various additives, residues from the process prior to the generation of the residue. Laccase enzymes also help to eliminate impurities, mainly lignin, which hinders pulping.

The Applicant has also discovered that fines hinder the processing of the diluted cellulosic industrial waste fibres, for example, they reduce the capacity for dewatering when the enzymatically treated industrial waste cellulosic fibres are compressed to produce compressed fibres. The transformation of fines into glucose helps in dewatering, but it is a process that must be controlled, as more fines could be generated from the larger cellulose fibres. The enzymatic treatment times and the enzyme concentration therefore needs to be controlled in order to control this transformation process in the industrial waste pulp.

Preferably, the step of diluting the enzymatically treated industrial waste fibres to obtain diluted enzymatically treated industrial waste fibres with a water content of greater than 90% comprises diluting to ensure the water content remains greater than 90% and less than 99%, preferably greater than 95% and less than 99%.

Preferably, the process further comprises:
(a) providing or producing pulped non-industrial waste cellulosic fibres derived from raw fibrous cellulosic material, preferably one of virgin cellulosic fibres or waste cellulosic fibres, preferably waste cardboard,
(b) enzymatically treating the pulped non-industrial waste cellulosic fibres, maintaining the water content during enzyme treatment above 80%,
(c) combining the enzymatically treated non-industrial waste cellulosic fibres with the enzymatically treated industrial waste cellulosic fibres,
(d) compressing the combined enzymatically treated non-industrial waste cellulosic fibres with the enzymatically treated industrial waste cellulosic fibres, and
(e) drying the compressed industrial and non-industrial waste cellulosic fibres to form a rigid cellulosic product.

Preferably, the step of producing pulped non-industrial waste cellulosic fibres comprises pulping the raw fibrous cellulosic material.

Alternatively however, the raw fibrous non-industrial waste cellulosic waste may not require a separate pulping step prior to enzymatic treatment, and can be supplied as already pulped fibres, that is fibres that are sufficiently individualised to be substantially free of agglomerations. Such a supply can be the direct output from a non-industrial plant, preferably a pulped output from a cardboard production plant.

The supplied pulped fibres can be directly fed from the pulped output from the cardboard production plant to the process for producing rigid cellulosic product via a conduit to the pulped output, or can be indirectly fed to the process for producing rigid cellulosic product via an intermediate storage tank.

Preferably, the process further comprises the step of diluting the enzymatically treated non-industrial waste cellulosic fibres to obtain diluted enzymatically treated cellulosic fibres with a water content of greater than 90%.

Preferably, the step of maintaining the water content during enzymatic treatment of the non-industrial waste cellulosic fibres above 80% comprises maintaining the water content during enzymatic treatment greater than 80% and up to 99%, more preferably greater than 80% and up to 95%.

Preferably, the raw fibrous industrial waste and the raw fibrous non-industrial waste cellulosic material are pulped independently of each other.

Preferably, the step of enzymatically treating the non-industrial waste cellulosic fibres comprises one or more of the following:
keeping the pH of the pulped fibres between 5 and 9,
maintaining the temperature above 40° C., preferably greater than 40° C. and less than 70° C. during the enzymatic treatment of step (b),
adding one or more enzymes selected from the group of xylanase, laccase, and cellulase,
adding between 0.05% to 0.5% of enzymes with respect to the dry weight of the industrial waste cellulosic fibres,
enzymatically treating the industrial waste cellulosic fibres for a period of greater than 5 minutes, preferably greater than 10 minutes and less than 90 minutes.

Preferably, the industrial waste and the non-industrial waste cellulosic fibres are enzymatically treated independently of each other.

Preferably, the industrial waste and the non-industrial waste cellulosic fibres are cleaned to remove contaminants independently of each other.

Preferably, the step of providing industrial waste cellulosic fibres comprises providing at least two sources of industrial waste cellulosic fibres, in which each source of industrial waste cellulosic fibres is pulped independently and enzymatically treated independently from each other.

Preferably, the industrial waste and the non-industrial waste cellulosic fibres are combined and mixed in the dilution step (c).

Preferably, the step of compressing the enzymatically treated industrial waste and/or non-industrial waste cellulosic fibres to form a rigid cellulosic product is one of moulding, preferably injection moulding, or pressing in a forming unit and/or between drums to form a partially wet cellulosic product.

Preferably, the step of compressing the enzymatically treated industrial waste and/or non-industrial waste cellulosic waste fibres to form a partially wet cellulosic product comprises pressing the enzymatically treated industrial waste and/or non-industrial waste cellulosic fibres in a forming unit to obtain a partially wet cellulosic product with a water content of preferably greater than 40% and less than 80%, preferably greater than 40% and less than 70%.

Preferably, the step of pressing the enzymatically treated industrial waste and/or non-industrial waste cellulosic fibres in a forming unit comprises:
(a) providing a forming unit, the forming unit having a mould defined by an outer side wall having open upper and lower ends, upper and lower plates configured to sealingly close the respective open upper and lower ends to retain the enzymatically treated industrial waste and/or non-industrial waste cellulosic fibres within the mould,
(b) introducing the enzymatically treated industrial waste and/or non-industrial waste cellulosic fibres into the mould, and
(c) moving the upper plate relative to the lower plate, preferably using a mechanical screw, to compress the enzymatically treated and/or cellulosic fibres between the upper and lower plates.

Preferably, a filter belt is provided between the lower plate and the mould such that a lower surface of the enzymatically treated and industrial waste and/or non-industrial waste cellulosic fibres are in contact with the filter belt.

Preferably, the filter belt has a porosity sufficient to substantially retain the solids content of the treated fibres with the mould and enable at least a proportion of the water content to pass therethrough, preferably the filter has a porosity rating of between 400 to 500 cubic feet per meter.

Preferably, a vacuum is applied to one or both of the upper and lower plates to remove water from the enzymatically treated industrial waste and/or non-industrial waste cellulosic fibres.

Preferably, the step of introducing the enzymatically treated industrial waste and/or non-industrial waste fibres into the mould comprises introducing the enzymatically treated industrial waste and/or cellulosic waste fibres through apertures provided on the outer side wall.

Preferably, the step of compressing the diluted enzymatically treated and pulped industrial waste and/or non-industrial waste cellulosic waste fibres to form a rigid cellulosic product comprises or further comprises pressing between drums, preferably to obtain a partially wet cellulosic product with a water content of greater than 40% and less then 80%, preferably less than 70%.

Preferably, the step of drying the compressed fibres to form a rigid cellulosic product comprises introducing the partially wet cellulosic product into a drying tunnel to reduce the water content, preferably at a temperature below 140° C., to reduce the water content preferably to below 40%, more preferably below 30%, most preferably below 25%.

Preferably, the step of drying the compressed fibres to form a rigid cellulosic product further comprises introducing the compressed and partially dried fibres into a hot plates press to reduce the water content, preferably to below 20%.

Preferably, the hot plates press comprises an upper plate and a lower plate, both plates configured to allow steam produced from water present in the partially wet cellulosic product to escape from the partially wet cellulosic product, preferably both plates comprise a mesh-like structure or are porous.

Preferably, the upper and lower plates of the hot plates pressure are maintained at a temperature of greater than 60° C. and up to 200° C.

Preferably, a pressure is applied to the partially wet cellulosic product in a first stage and a second stage.

Preferably, in the first stage, a pressure of lower than 2 kg/cm² is applied.

Preferably, in the second stage, a pressure of greater than 0.5 kg/cm² is applied to obtain the rigid cellulosic product with the required density or thickness, preferably with a water content of lower than 20%.

Preferably, the process is a continuous process.

Preferably, the raw fibrous industrial waste comprises other compounds, such as inorganic compounds and/or other impurities.

Preferably, the rigid cellulosic product is a board, preferably a construction board.

Preferably, the board has one or more of the following properties:
at least 20% by weight of industrial waste fibres compared to the final rigid cellulosic product weight,
a thickness of between 3 mm and 22 mm,
an internal bond strength of at least 0.1 MPa,
a flexural strength of at least 4 MPa, and
a density of at least 400 kg/m³.

Preferably, the quantity of industrial waste cellulosic fibres is selected such that the calcium carbonate content compared to the weight of the rigid cellulosic product is sufficient to obtain a rigid cellulosic product having a Class C fire classification when tested according to European Standard EN 13501-1.

Preferably, the rigid cellulosic board has a calcium carbonate content of greater than 7 wt. % and preferably less than 50%, more preferably less than 35 wt. % compared to the weight of the rigid cellulosic product.

Preferably, the method further comprises the step of measuring the calcium carbonate content of the combined enzymatically treated industrial waste and/or non-industrial waste cellulosic fibres prior to compressing the fibres, and checking the measured calcium carbonate content with a reference which correlates the calcium carbonate content of the combined enzymatically treated industrial waste and/or non-industrial waste fibres prior to compressing the fibres with an expected calcium carbonate content of the rigid cellulosic product.

Preferably, the process further comprises adding a fire retardant, preferably aluminium hydroxide, to the non-industrial waste cellulosic fibres, preferably waste cardboard.

Preferably, the step of adding a fire retardant is after the step (b) of enzymatically treating the pulped non-industrial waste cellulosic fibres and more preferably before step (c) of combining the enzymatically treated and pulped industrial and non-industrial waste cellulosic fibres.

Preferably, the aluminium hydroxide is added in sufficient quantity such that the rigid cellulosic product has an aluminium hydroxide content of greater than 15 wt. % dry mass compared to the weight of the rigid cellulosic product to provide the rigid cellulosic product with a Class B fire classification when tested according to European Standard EN 13501-1.

Preferably, the non-industrial waste cellulosic fibres are any cellulosic fibres that are not derived from raw fibrous industrial waste, more preferably one or more of virgin cellulosic fibres, preferably wood or plant fibres, more preferably Miscanthus fibres, or preferably waste paper or waste cardboard fibres, preferably OCC fibres.

According to another aspect of the present invention there is provided a process for producing rigid cellulosic product comprising the steps of:
(a) providing cellulosic fibres,
(b) enzymatically treating the cellulosic fibres, maintaining the water content during enzyme treatment above 80%,
(c) compressing the enzymatically treated cellulosic fibres to produce compressed fibres, and
(d) drying the compressed fibres to form a rigid cellulosic product.

Preferably, the cellulosic fibres are one are one of virgin cellulosic fibres, preferably wood or plant fibres, more preferably Miscanthus fibres, or preferably waste paper or waste cardboard fibres, preferably OCC fibres.

Preferably, the cellulosic fibres are 100% waste cardboard fibres, in which the process further comprises adding a fire retardant, preferably aluminium hydroxide, to the waste cardboard fibres, preferably adding the fire retardant after step (b) of enzymatically treating the waste cardboard fibres.

Preferably, the process does not include the step of adding a binder, glue or adhesive to bind the fibres together.

Preferably, the rigid cellulosic product comprises a proportion of rejected rigid cellulosic product.

Preferably, the process further comprises the step of adding the rejected rigid cellulosic product to the step of diluting or pulping or enzymatically treating the industrial waste or non-industrial waste cellulosic fibres.

Preferably, the combined industrial waste and non-industrial waste cellulosic fibres comprise at least 20 wt. %, preferably between 20 and 80 wt. %, preferably between 30 and 70 wt. %, preferably between 40 and 60 wt. % of the industrial waste cellulosic fibres, the remainder of the combined industrial and non-industrial waste cellulosic fibres being cellulosic fibres.

According to another aspect of the present invention, there is provided a process for producing rigid cellulosic product from industrial waste fibres comprising the steps of:
(a) providing industrial waste cellulosic fibres derived from raw fibrous industrial waste, preferably primary sludge from a paper production process,
(b) enzymatically treating the industrial waste cellulosic fibres, maintaining the water content during the enzyme treatment above 80%,
(c) providing non-industrial waste fibres, preferably waste cardboard,
(d) enzymatically treating the non-industrial waste cellulosic fibres, maintaining the water content during pulping and enzyme treatment above 80%,
(e) combining the enzymatically treated non-industrial waste cellulosic fibres with the enzymatically treated industrial waste cellulosic fibres,
(f) compressing the combined enzymatically treated and industrial and non-industrial waste cellulosic fibres, and
(g) drying the compressed industrial and non-industrial waste cellulosic fibres to form a rigid cellulosic product.

Preferably, the industrial and/or non-industrial waste cellulosic fibres are pulped and/or diluted prior to enzymatic treatment.

Preferably, the process further comprises adding a fire retardant, preferably an expandable volcanic based material, preferably vermiculite, to the industrial or non-industrial waste cellulosic fibres, preferably waste cardboard, preferably in a sufficient quantity to provide the rigid cellulosic product with a Class B fire classification when tested according to European Standard EN 13501-1.

Preferably, greater than 5 wt. % of expandable volcanic based material compared to the weight of the rigid cellulosic board is added to the non-industrial waste cellulosic fibres, preferably after the step of enzymatically treating the non-industrial waste cellulosic fibres and more preferably before the step of combining the enzymatically treated industrial and non-industrial waste cellulosic fibres.

According to another aspect of the present invention, there is provided a rigid cellulosic product comprising one or both of enzymatically treated industrial waste cellulosic fibres and enzymatically treated non-industrial waste cellulosic fibres.

Preferably, the rigid cellulosic product does not include a binder, glue or adhesive to bind the fibres together.

Preferably, the rigid cellulosic product has a calcium carbonate content of greater than 7 wt. % and preferably less than 50%, more preferably less than 35 wt. % compared to the weight of the rigid cellulosic product.

Preferably, the rigid cellulosic product has an aluminium hydroxide content of greater than 15 wt. % dry mass compared to the weight of the rigid cellulosic product.

Preferably, the industrial waste cellulosic fibres are derived from primary sludge obtained from the paper production industry.

Preferably, the non-industrial waste cellulosic fibres are derived from waste cardboard.

Preferably, the rigid cellulosic product comprises between 20 and 80 wt. %, preferably between 30 and 70 wt. %, preferably between 40 and 60 wt. % of the industrial waste cellulosic fibres, the remainder of the combined industrial and non-industrial waste cellulosic fibres being non-industrial waste cellulosic fibres.

Preferably, the rigid cellulosic product has one or more of the following properties:
at least 20% by weight of industrial waste fibres compared to the final rigid cellulosic product weight,
a thickness of between 3 mm and 22 mm,
an internal bond strength of at least 0.1 MPa,
a flexural strength of at least 4 MPa, and
a density of at least 400 kg/m³.

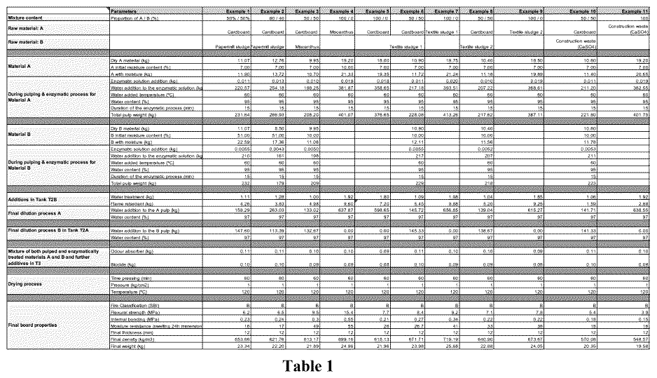

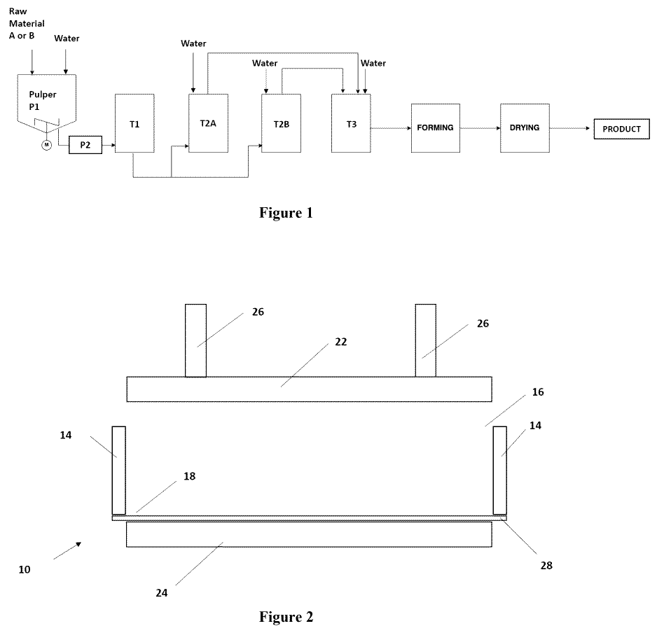

The invention will now be described with reference to FIGS. 1 to 5, Table 1, and Examples 1 to 11 below, in which

FIG. 1 is a schematic view of the process of the present invention, and

FIG. 2 is a front sectional view of a forming unit used in the process of the present invention prior to the injection of pulp,

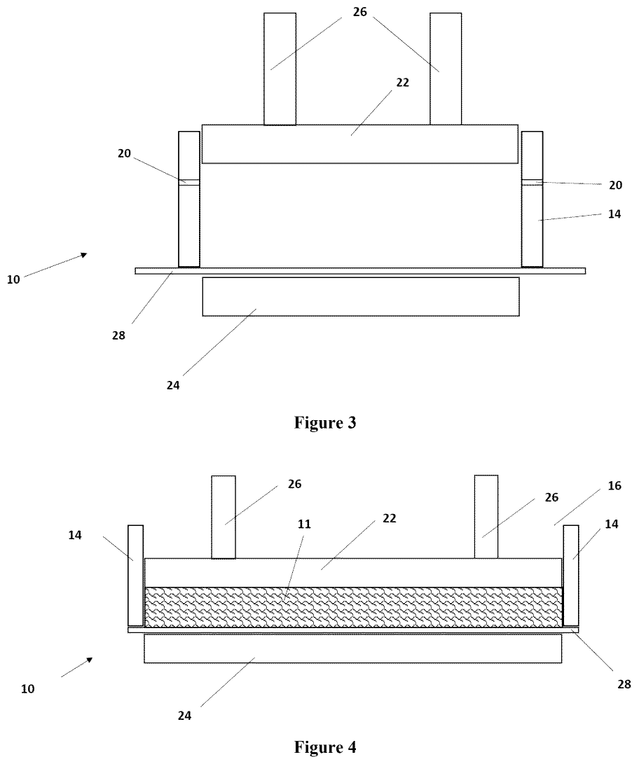

FIG. 3 is a side sectional view of the forming unit of FIG. 2 prior to the injection of pulp,

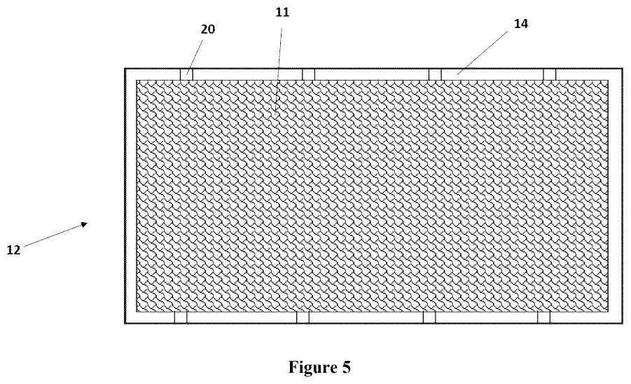

FIG. 4 is a front sectional view of the forming unit of FIG. 1, after the injection of pulp, and

FIG. 5 is a plan sectional view of the forming unit of FIG. 1 after the injection of pulp (with upper plate removed for clarity).

References to water content are weight percentage, and further mean the percentage of water compared to the amount of solids, for example, 80% water content will contain 20% solids.

References to percentage proportions of industrial and non-industrial materials mean the dry mass of that material compared to the total dry mass of industrial and non-industrial material.

### Example 1

With reference to FIG. 1 and Table 1, raw fibrous non-industrial waste cellulosic material A is provided in the form of waste cardboard, specifically, old corrugated cardboard (OCC), and raw fibrous industrial waste cellulosic material B is provided in the form of raw papermill sludge, that is, primary sludge from the paper production industry.

In this example, the raw fibrous content is 50% sludge and 50% OCC (both measured in dry weight). It will be understood that the sludge content can be up to 100%, with the remainder being OCC.

The sludge and OCC are independently diluted, pulped, and enzymatically treated as will be described below.

### OCC Processing

Firstly, hot water at a temperature of 60° C. is pumped into a pulper P1.

The OCC is then loaded into the pulper P1 and stirred in water for at least 8 minutes to individualize and improve the fibre distribution in the OCC before the enzymes are added, to produce pulped OCC. If required, water is added to the OCC in the pulper P1 to ensure a water content of 95%. In alternative embodiments, the OCC could be supplied with a water content of greater than 95%, in which case, water is removed or more solids added, to establish a water content of 95% in this example. By individualize it is meant the process of dispersing the fibres which are agglomerated in the raw OCC.

Enzymes in the form of xylanase, laccase, and cellulase, are then added to the diluted and pulped OCC fibres in the pulper P1 and agitated or stirred for at least 5 minutes and up to 90 minutes (depending on the pulping equipment) to produce pulped and enzymatically treated OCC with a water content maintained above 90%, in this example, at about 95%.

The enzymes are preferably liquid or dissolved in liquid and are added to the pulped OCC waste fibres. The added enzymes are preferably selected to smooth the fibres, remove radicals from the outside of the fibres and increase the specific surface area of the fibres. Those effects can be obtained for example by different combinations of the following enzymes: xylanase, laccase, cellulase and/or combinations thereof.

During the enzymatic treatment, the pH of the pulped fibres is maintained between 5 and 9.

The temperature of the pulped fibres is maintained above 40° C., preferably between 40° C. and 70° C., to improve the enzymatic treatment. In this example, the temperature of the pulped fibres is maintained at 60° C.

The total quantity of enzymes added is between 0.05% to 1% with respect to the dry weight of the OCC fibres.

Alkyl ketene dimer (AKD) is added as part of the water treatment additions in T2B to the pulped and enzymatically treated OCC fibres. The amount of AKD added is less than 15% compared to the weight of the OCC. After adding the AKD, the agitator continues to run for about 4 minutes. Optionally, the diluted, pulped and enzymatically treated OCC contents of the pulper P1 are then subjected to a cleaning process by being transferred to a tank T1 via a sieving tank P2 where contaminants, such as plastic, wood or metal, with a size larger than 6 mm are removed in a first cleaning stage, and further contaminants which are smaller than 6 mm and therefore are not removed in the first cleaning stage, but heavier than the aforementioned contaminants are removed using a hydrocyclone in a second cleaning stage. Examples of such smaller but heavier contaminants include staples, crystals and sand.

The OCC pulp independently produced in tank T1 is then transferred to tank T2B and the stirrer is started. The OCC pulp is diluted to a water content of 97%.

### Sludge Processing

The dilution, pulping and enzymatic treatment steps described above are repeated in the pulper P1 (after the pulped, diluted and enzymatically treated OCC has been removed) using the sludge, other than that that the enzyme treatment stage is required for greater than 5 minutes, but less than 60 minutes, and the enzyme concentration is between 0.05% and 0.5% with respect to the dry weight of the sludge fibres. The enzyme treatment time and concentration is approximately 50% less for the sludge fibres compared to the OCC fibres.

In an alternative embodiment, the sludge can be pulped in a different pulper, that is not the same pulper used for the dilution, pulping and enzymatic treatment of the OCC.

Optionally, the pulped and enzymatically treated sludge contents of the pulper P1 are cleaned according to the same process described above in relation to the OCC.

The sludge pulp independently (either before or after the OCC pulp is produced) produced in tank T1 is then transferred to tank T2A and the stirrer is started. The sludge pulp is diluted to a water content of 97%.

It will be understood that the OCC and the sludge are independently pulped and enzymatically treated in steps (a) and (b) above, that is, the OCC is pulped and enzymatically treated and transferred to tank T1, and then the sludge is independently pulped and enzymatically treated and transferred to tank T1. In addition the sludge and OCC independently undergo the two-stage cleaning process by being sieved in sieving tank P2 and cleaned in tank T1.

An aluminium hydroxide based fire retardant is added to the OCC pulp in tank T2B. The OCC pulp is then circulated in tank T2B.

50% of the sludge pulp in tank T2A and 50% of the OCC pulp with the added fire retardant in tank T2B is then transferred to tank T3 where it is combined and stirred.

Further additives such as odour powder, biocides, and inks/dyes are added to the combined sludge and OCC pulp in tank T3.

If needed, the combined sludge and OCC pulp is further diluted by adding more to ensure a water content of greater than 90%.

### Forming

With reference to a forming unit 10 of FIGS. 2 to 5, the combined sludge and OCC pulp 11 is compressed as follows:
The forming unit 10 includes a rectangular mould 12 defined by an outer side wall 14 having an open upper end 16 and an open lower end 18. The outer side wall 14 includes multiple apertures 20 distributed on each longer side of the outer side wall 14, through which the combined sludge and OCC pulp 11 is injected as will be described below. The distribution and number of apertures can vary to ensure an equal distribution of pulp 11 inside the mould 12. This is important as it enables control of the density and thickness of the final rigid cellulosic product.

The forming unit 10 further includes an upper plate 22 and a lower plate 24, the upper plate 22 being movable relative to the lower plate 24 via a mechanical screw system 26 which is driven by an electric motor (not shown).

The upper 22 and lower 24 plates have a compartmentalized structure that acts as a box that can temporarily store extracted water from the pulp 11.

A PET conveying filter belt 28 is positioned between the lower plate 24 and the mould 12 such that it sealing engages against the outer side wall 14 of the mould 12 to retain the pulp 11 within the mould 12. The filtering belt 28 has a porosity sufficient to substantially retain the solids content of the treated fibres with the mould and enable at least a proportion of the water content to pass therethrough, in this embodiment, a porosity rating of between 400 to 500 cubic feet per meter which is sufficient to enable the extraction of water from the pulp 11, but at the same time avoiding undesired extraction of cellulose fibres from the pulp 11.

In operation, the combined sludge and OCC pulp 11 is injected through the apertures 20 into the mould 12 of a forming unit 10. The pulp 11 is retained horizontally by the outer side wall 14 and vertically by the filter belt 28 (FIGS. 2 and 3).

Once the desired amount of pulp 11 has been introduced into the mould 12, a dewatering step is initiated by applying a vacuum to the lower plate 24 to extract water from the pulp 11 through the filter belt 28. The extracted water is deposited inside the lower plate 24. Alternatively, no vacuum is applied, and the water can be extracted under gravity.

At the same time as the water is being extracted from the pulp 11, the upper plate 22 is lowered via the mechanical screw system until it comes into contact with the pulp 11 and applies a pressure which depends on the density of product required (FIG. 4). When the upper plate 22 presses the pulp 11 against the lower plate 24, a vacuum is applied to the upper plate 22 to extract more water from the pulp 11 through upper plate 22 where it is deposited. Alternatively, a positive pressure can be applied inside the mould instead of applying a vacuum.

When a sufficient amount of water has been removed from the pulp 11, a partially wet cellulosic product in the form of a board is formed. Typically the water content is greater than 40% and less then 80% and enables the partially wet cellulosic board to be removed from the forming unit 10. The partially wet cellulosic board is removed from the forming unit 10 by firstly raising the upper plate 22 to its starting position (FIG. 2), lifting the mould 12 from the filter belt 28, and then starting the conveying filter belt 28 to move the partially wet cellulosic board to a transfer unit (not shown) where it undergoes an optional compression step in the form of pressing rollers or drums to squeeze remaining water from the wet partially wet cellulosic board and reduce the water content further, typically to less than 70% to about 40%.

In an alternative embodiment, the combined pulp 11 can be compressed between pressing rollers to form a partially wet cellulosic board without requiring forming in the forming unit 10.

### Drying

The partially wet cellulosic board is dried in two stages as follows:

In a first drying stage, the board is introduced into a convection drying tunnel and is moved on belt at a speed of 0.04 to 0.05 m/min and exposed to a temperature of 120° C. for a residence time of 4 to 5 hours.

When the board exits the drying tunnel, the water content of the board is between 20 and 30%.

In a second drying stage, the board is removed from the drying tunnel and positioned between two plates of a hot plates press.

The hot plates press includes an upper hot press plate and a lower hot press plate, both plates configured to allow steam produced when the board is heated from water present in the partially wet cellulosic board to escape. In this embodiment, both the upper and lower plates have a mesh-like structure to allow the steam to escape. In an alternative, the plates can be made of a porous material, or include micro-perforations.

The upper and lower plates of the hot plates press are maintained at a temperature of greater than 60° C. and up to 200° C. during pressing.

In a first press drying stage, a pressure of lower than 2 kg/cm² is applied to the board. In this first stage, the board contacts the press hot plates and is heated through conduction. The pressure applied during this first stage depends on the required final board density but must be lower than 2 kg/cm². In this first stage, the board achieves a water content of lower than 50%.

In a second press drying stage, a pressure of greater than 0.5 kg/cm² is applied to the board so as to obtain the rigid cellulosic product with the required density or thickness. In the second press drying stage, the maximum pressure that can be applied to the board is not limited as in the first press drying stage due to the reduced compressibility of the board as it has a lower water content.

After the second stage, the now rigid cellulosic board has a water content of about 20%.

In this embodiment, the partially wet cellulosic board is transferred from the forming unit via the press rollers and the drying tunnel to the hot plates press. In an alternative embodiment, the partially wet cellulosic board can be transferred directly from the forming unit to the hot plates press without the need for the drying tunnel.

After exiting the hot plates press, the board is allowed to cool for at least 30 minutes on a support that is covered by a mesh to allow remaining water vapour to evaporate from both sides of the board.

In the above embodiment, the partially wet cellulosic board undergoes a first drying stage in a drying tunnel. In alternative embodiments, a single stage drying process is possible requiring only the use of the drying tunnel or the hot plates press.

Alternative drying technologies such as radio or microwave frequency drying, infrared drying or direct conduction drying are envisaged.

The board produced has the properties defined in Table 1, particularly noting the board achieves a Class B fire classification (SBI) when tested according to European Standard EN 13501-1.

In an alternative embodiment, the aluminium hydroxide fire retardant is not added to the pulped and enzymatically treated OCC. Instead, the quantities of calcium carbonate in the sludge are sufficiently high, about 10% compared to the weight of the final board in this example to achieve a Class C fire classification (SBI) when tested according to European Standard EN 13501-1 as opposed to the Class B fire classification (SBI) of Example 1.

To ensure the calcium carbonate content is sufficient to achieve Class C, the calcium carbonate content of the raw sludge is measured for each batch prior to compressing the fibres, and the measured calcium carbonate content is compared with a look-up reference which correlates the calcium carbonate content of the sludge with an expected calcium carbonate content of the rigid cellulosic product based on the proportion of sludge in the final product. If the calcium carbonate content is too low, it is adjusted to ensure the quantity is sufficient, that is, greater than 7 wt. % and less than 50 wt. % compared to the weight of the final board to achieve a Class C fire classification (SBI). Adjustment of the calcium carbonate level is achieved by adjusting the ratio of OCC to sludge.

Other than the fire classification, the final board properties are 5 to 10% higher than those for the board of Example 1.

In this alternative embodiment, in contrast to Example 1, the pulped and enzymatically treated sludge and the pulped and enzymatically treated OCC are not independently sieved in sieving tank P2 and cleaned in tank T1, but undergo the two-stage cleaning process after being combined.

### Example 2

With reference to Table 1, Example 2 is identical to Example 1 except that the mixture content is 60% sludge and 40% OCC.

The board produced has the properties defined in Table 1.

### Example 3

Example 3 is identical to Example 1 except that in addition to the 50% OCC, the mixture content comprises 50% industrial waste in the form of Miscanthus.

The board produced has the properties defined in Table 1.

### Example 4

Example 4 is identical to Example 3 except that the mixture content comprises 100% non-industrial waste in the form of plant fibres, in this example, miscanthus fibres.

The board produced has the properties defined in Table 1.

### Example 5

Example 5 is identical to Example 3 except that the mixture content comprises 100% non-industrial waste in the form of OCC.

The board produced has the properties defined in Table 1.

### Example 6

Example 6 is identical to Examples 1 and 3 except that, in addition to the 50% OCC, the mixture content comprises 50% industrial waste in the form of textile sludge, that is sludge originating from the textile processing industry.

The board produced has the properties defined in Table 1.

### Example 7

Example 7 is identical to Example 6 except that the mixture content comprises 100% industrial waste in the form of textile sludge.

Instead of adding aluminium hydroxide to the OCC, an alternative fire retardant, vermiculite, is added to the sludge to achieve a Class B fire classification (SBI) when tested according to European Standard EN 13501-1 as opposed to the Class B fire classification (SBI) of Example 1.

The board produced has the properties defined in Table 1.

### Example 8

Example 8 is identical to Example 6 except that the textile sludge has shorter fibres and includes a mixture or organic and synthetic fibres which do not generate hydrogen bonds.

The board produced has the properties defined in Table 1.

### Example 9

Example 9 is identical to Example 7 except that the textile sludge has shorter fibres and includes a mixture or organic and synthetic fibres which do not generate hydrogen bonds.

The board produced has the properties defined in Table 1.

### Example 10

Example 10 is identical to Example 1, 3 and 6 except that, in addition to the 50% OCC, the mixture content comprises 50% industrial waste in the form of construction waste (calcium sulphate) as opposed to paper sludge.

The board produced has the properties defined in Table 1.

### example 11

Example 11 is identical to Example 10 except that the mixture content comprises 100% industrial waste in the form of construction waste (calcium sulphate).

Instead of adding aluminium hydroxide to the OCC, an alternative fire retardant, vermiculite, is added to the construction waste to achieve a Class B fire classification (SBI) when tested according to European Standard EN 13501-1 as opposed to the Class B fire classification (SBI) of Example 1.

The board produced has the properties defined in Table 1.

In Examples 4, 5, 7, 9 and 11, there is only a single cellulosic fibre source, and therefore no requirement to independently clean that single fibre source, or to combine another cellulosic fibre source as is the case in Examples 1, 2, 3, 6, 8 and 10.

In Examples 2 to 11 above, either aluminium hydroxide or vermiculite is added as a fire retardant to achieve a Class B rating.

In alternative embodiments, the quantity of calcium carbonate in the sludge is sufficiently high as described in relation to the alternative embodiment of Example 1 to achieve a Class C rating. Other than the fire classification, the final board properties are 5 to 10% higher than those for the board of Examples 2 to 11.

In these alternative embodiments, in contrast to Examples 2 to 11, the pulped and enzymatically treated industrial waste, that is the sludge (textile or paper processing derived), Miscanthus, or the construction waste, and the pulped and enzymatically treated non-industrial waste, that is OCC, are not independently sieved in sieving tank P2 and cleaned in tank T1, but undergo the two-stage cleaning process after being combined and the sieved in sieving tank P2 and cleaned in tank T1. Instead of adding aluminium hydroxide to the OCC, in alternative embodiments, an expandable volcanic based material, such as vermiculite or perlite, can be added to the OCC to provide a rigid cellulosic product with a Class B fire classification when tested according to European Standard EN 13501-1.

In another alternative, the expandable volcanic based material can be added to the sludge to provide a rigid cellulosic product with a Class B fire classification when tested according to European Standard EN 13501-1.

The above embodiments describe boards with combinations of industrial and non-industrial waste, such as waste cardboard and different industrial sources of sludge, as well as examples of only a single fibre source such as waste cardboard or different industrial sources of sludge. In alternative embodiments, the board can have combinations of industrial waste only, for example, a mixture of paper sludge and textile sludge.

In the above embodiments, the final thickness of the rigid board is 12 mm. In alternative embodiments, the final thickness can be varied between 3 and 22 mm by varying the weight of the solids content introduced into the forming unit. It will be understood that different thickness boards will require different drying regimes.

In the above embodiments, the process is not continuous, specifically transfer of the partially wet board from the forming unit to the transfer unit, and then to the drying tunnel and the hot plates press are manual processes. In alternative embodiments the process from initial pulping through to the drying of the board can be a continuous process.

It will be understood that the above described forming and drying processes and equipment are not limited to mixtures of industrial waste with non-industrial waste, and can be applied to any cellulosic fibre source, either a single fibre source or mixtures of fibre sources.

In the above embodiments, the raw fibrous industrial and non-industrial waste cellulosic material is pulped prior to being enzymatically treated, formed and dried. In alternative embodiments, either or both of the raw fibrous industrial and non-industrial waste cellulosic material waste may not require a separate pulping step prior to enzymatic treatment, and can be supplied as already pulped fibres. Such a supply can be the direct output from a non-industrial plant, for example, a pulped output from a waste cardboard production plant, and/or a direct output from an industrial plant, preferably a pulped output from a paper production plant. Such a supply can be a direct feed from the industrial and non-industrial plants, in which case an plant which integrates a paper and/or cardboard production plant with the process for producing a rigid cellulosic product is envisaged. Alternatively, the plants need not be integrated, and the pulped output can be stored before being fed or transferred to the process for producing rigid cellulosic product.

1. A process for producing rigid cellulosic product from raw fibrous industrial waste comprising the steps of:
(a) providing or producing pulped industrial waste cellulosic fibres derived from raw fibrous industrial waste,
(b) enzymatically treating the pulped industrial waste cellulosic fibres to produce enzymatically treated industrial waste cellulosic fibres, maintaining the water content during enzyme treatment above 80%,
(c) compressing the enzymatically treated industrial waste cellulosic fibres to produce compressed fibres, and
(d) drying the compressed fibres to form a rigid cellulosic product.

2. The process according to claim 1 in which the step of producing pulped industrial waste cellulosic fibres comprises pulping the raw fibrous industrial waste.

3. The process according to claim 1 further comprising the step of diluting the raw fibrous industrial waste in water prior to, or during pulping.

4. The process according to claim 1 in which the pulped industrial waste cellulosic fibres are provided as a feed, preferably a direct feed, from an industrial plant, preferably a sludge output feed from a plant to produce paper or textiles.

5. The process according to claim 1 further comprising the step of diluting the enzymatically treated industrial waste cellulosic fibres to obtain diluted enzymatically treated industrial waste cellulosic fibres with a water content of greater than 90%.

6. The process according to claim 1 in which the raw fibrous industrial waste comprises fibres having an average length of less than 5 mm, preferably less than 2 mm, and/or an average width of less than 0.1 mm, and/or a mass percentage of fines greater than 10%.

7. (canceled)

8. (canceled)

9. (canceled)

10. The process according to claim 1 in which the step of enzymatically treating the industrial waste cellulosic fibres comprises one or more of the following:
keeping the pH of the pulped fibres between 5 and 9,
maintaining the temperature above 40° C., preferably greater than 40° C. and less than 70° C. during the enzymatic treatment of step (b),
adding one or more enzymes selected from the group of xylanase, laccase, and cellulase,
adding between 0.05% to 0.5% of enzymes with respect to the dry weight of the industrial waste cellulosic fibres,
enzymatically treating the industrial waste cellulosic fibres for a period of greater than 5 minutes, preferably greater than 5 minutes and less than 60 minutes.

11. (canceled)

12. The process according to claim 1 further comprising:
(a) providing or producing pulped non-industrial waste cellulosic fibres derived from raw fibrous non-industrial waste cellulosic material, preferably one of virgin cellulosic fibres or waste cellulosic fibres, preferably waste cardboard,
(b) enzymatically treating the pulped non-industrial waste cellulosic fibres, maintaining the water content during enzyme treatment above 80%,
(c) combining the enzymatically treated non-industrial waste cellulosic fibres with the enzymatically treated non-industrial waste cellulosic fibres,
(d) compressing the combined enzymatically treated non-industrial waste cellulosic fibres with the enzymatically treated industrial waste cellulosic fibres, and
(e) drying the compressed industrial waste and non-industrial waste cellulosic fibres to form a rigid cellulosic product.

13. (canceled)

14. (canceled)

15. (canceled)

16. (canceled)

17. The process according to claim 12 in which the raw fibrous industrial waste and the raw fibrous non-industrial waste cellulosic material are pulped independently of each other.

18. The process according claim 12 in which the industrial waste cellulosic fibres and the non-industrial waste cellulosic fibres are enzymatically treated independently of each other.

19. (canceled)

20. (canceled)

21. (canceled)

22. The process according to claim 1 in which the step of compressing the enzymatically treated industrial waste and/or non-industrial waste cellulosic fibres to form a partially wet cellulosic product comprises pressing the enzymatically treated industrial waste and/or non-industrial waste cellulosic fibres in a forming unit to obtain a partially wet cellulosic product with a water content of preferably greater than 40% and less than 80%, preferably greater than 40% and less than 70%.

23. The process according to claim 22 in which the step of pressing the enzymatically treated industrial waste and/or non-industrial waste cellulosic fibres in a forming unit comprises:
(a) providing a forming unit, the forming unit having a mould defined by an outer side wall having open upper and lower ends, upper and lower plates configured to sealingly close the respective open upper and lower ends to retain the enzymatically treated industrial waste and/or cellulosic fibres within the mould,
(b) introducing the enzymatically treated industrial waste and/or non-industrial waste cellulosic fibres into the mould, and
(c) moving the upper plate relative to the lower plate, preferably using a mechanical screw, to compress the enzymatically treated and/or non-industrial waste cellulosic fibres between the upper and lower plates.

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. The process according to claim 17 in which the combined industrial waste and non-industrial waste cellulosic fibres comprise at least 20 wt. %, preferably between 20 and 80 wt. %, preferably between 30 and 70 wt. %, preferably between 40 and 60 wt. % of the industrial waste cellulosic fibres, the remainder of the combined industrial and cellulosic fibres being non-industrial waste cellulosic fibres.

46. A process for producing rigid cellulosic product from industrial waste fibres comprising the steps of:
(a) providing industrial waste cellulosic fibres derived from raw fibrous industrial waste, preferably primary sludge from a paper production process,
(b) enzymatically treating the industrial waste cellulosic fibres, maintaining the water content during the enzyme treatment above 80%,
(c) providing non-industrial waste fibres, preferably waste cardboard,
(d) enzymatically treating the non-industrial waste cellulosic fibres, maintaining the water content during pulping and enzyme treatment above 80%,
(e) combining the enzymatically treated non-industrial waste cellulosic fibres with the enzymatically treated industrial waste cellulosic fibres,
(f) compressing the combined enzymatically treated and industrial and non-industrial waste cellulosic fibres, and
(g) drying the compressed industrial and non-industrial waste cellulosic fibres to form a rigid cellulosic product.

47. (canceled)

48. (canceled)

49. (canceled)

50. A rigid cellulosic product comprising one or both of enzymatically treated industrial waste cellulosic fibres and enzymatically treated non-industrial waste cellulosic fibres.

51. (canceled)

52. (canceled)

53. (canceled)

54. The rigid cellulosic product according to claim 50 in which the industrial waste cellulosic fibres are derived from primary sludge obtained from a paper production plant and the non-industrial waste cellulosic fibres are derived from waste cardboard.

55. (canceled)

56. The rigid cellulosic product according to claim 54, in which the product has one or more of the following properties:
at least 20% by weight of industrial waste fibres compared to the final rigid cellulosic product weight,
a thickness of between 3 mm and 22 mm,
an internal bond strength of at least 0.1 MPa,
a flexural strength of at least 4 MPa, and
a density of at least 400 kg/m³.

57. The rigid cellulosic product according to claim 54 which does not include a binder, glue or adhesive to bind the cellulosic fibres together.

58. The rigid cellulosic product according to 54 comprising an aluminium hydroxide content of greater than 15 wt. % dry mass compared to the weight of the rigid cellulosic product so as to obtain a Class B fire classification when tested according to European Standard EN 13501-1.

59. The rigid cellulosic product according to claim 54 having a calcium carbonate content of greater than 7 wt. % and preferably less than 50%, more preferably less than 35 wt. % compared to the weight of the rigid cellulosic product so as to obtain a rigid cellulosic product having a Class C fire classification when tested according to European Standard EN 13501-1.
